(19) United States
(12) Patent Application Publication
(10) Pub. No.: US 2025/0197610 A1
(43) Pub. Date: Jun. 19, 2025

(54) CELLULAR NATURAL RUBBER ARTICLES

(71) Applicant: BRIDGESTONE AMERICAS TIRE OPERATIONS, LLC, Nashville, TN (US)

(72) Inventors: Dian YUAN, Peninsula, OH (US); Kentaro KAYASHIMA, Copley, OH (US); Jared J. GRIEBEL, Orange, OH (US); Piotr KOZMINSKI, Akron, OH (US); Yingyi HUANG, Hudson, OH (US)

(21) Appl. No.: 18/720,837

(22) PCT Filed: Dec. 15, 2022
(86) PCT No.: PCT/US2022/081651

§ 371 Date: Jun. 17, 2024

Related U.S. Application Data
(60) Provisional application No. 63/289,899, filed on Dec. 15, 2021.

(51) Int. Cl. C08L 7/00; C08J 9/10

(52) U.S. Cl. CPC C08L 7/00; C08J 9/103; C08J 2203/04; C08J 2307/00; C08L 2203/14

(57) ABSTRACT

A method for forming a natural rubber-chemical blowing agent composite, the method comprising (a) providing a natural rubber cement; (b) introducing a blowing agent to the natural rubber cement to form a solvent-borne mixture including the natural rubber and blowing agent; and (c) desolventizing the solvent-borne mixture to form a natural rubber-chemical blowing agent composite.

### FIELD OF THE INVENTION

Embodiments of the present invention are directed toward cellular natural rubber articles characterized by advantageous physical properties and methods for making the cellular articles by employing solution mixing techniques. Particular embodiments employ guayule cis-1,4-polyisoprene.

### BACKGROUND OF THE INVENTION

Foam products have been prepared by using rubber polymers. In so doing, the polymeric composition is foamed. This can be accomplished by using a chemical or physical blowing agent to create voids or cells within the composition. The foamed composition is cured by crosslinking the rubber polymers, which thereby locks the cells of the foam in place.

### SUMMARY OF THE INVENTION

One or more embodiments of the present invention provide a method for forming a natural rubber-chemical blowing agent composite, the method comprising (a) providing a natural rubber cement; (b) introducing a blowing agent to the natural rubber cement to form a solvent-borne mixture including the natural rubber and blowing agent; and (c) desolventizing the solvent-borne mixture to form a natural rubber-chemical blowing agent composite.

Yet other embodiments of the present invention provide a method for forming a foamed rubber article, the method comprising (i) providing the natural rubber-chemical blowing agent composite prepared by a method comprising (i-a) providing a natural rubber cement; (i-b) introducing a blowing agent to the natural rubber cement to form a solvent-borne mixture including the natural rubber and blowing agent; and (i-c) desolventizing the solvent-borne mixture to form a natural rubber-chemical blowing agent composite; (ii) introducing a curative to the composite to form a foamable, vulcanizable composition; (iii) forming a profile from the foamable, vulcanizable composition; and (iv) heating the profile to a temperature sufficient to decompose the chemical blowing agent and vulcanize the rubber.

### DETAILED DESCRIPTION OF ILLUSTRATIVE EMBODIMENTS

Embodiments of the invention are based, at least in part, on the discovery of cellular natural rubber articles prepared by a method that includes blending a chemical blowing agent with a natural rubber cement. The cement, which includes a solvent-borne mixture of natural rubber polymer and chemical blowing agent, is then desolventized to form a natural rubber-chemical blowing agent composite. The curative for the rubber can then be introduced to the composite to form a vulcanizable composition that can be cured to form the cellular natural rubber articles. By introducing the chemical blowing agent to the natural rubber cement, it has unexpectedly been discovered that the chemical blowing agent is more evenly dispersed in the natural rubber. This dispersion in turn leads to several benefits including smaller, more evenly dispersed cells, which provides for improved mechanical properties.

Accordingly, embodiments of the invention provide a method that includes (i) providing a natural rubber cement, (ii) introducing a chemical blowing agent to the cement to form a solvent-borne mixture, and (iii) desolventizing the mixture to form a natural rubber-chemical blowing agent composite.

### Providing a Rubber Cement

As indicated above, a natural rubber cement is provided. This cement includes polymer obtained from a source of natural rubber, and the polymer is dissolved or otherwise entrained in an organic solvent. The polymer is included in the solids portion of the cement. The solids portion may include dissolved solids and suspended or dispersed solids. As will be discussed in greater detail below, the solids portion of the cement may also include other constituents that may be added to the cement, such as the chemical blowing agent.

### Natural Rubber

Several sources of natural rubber are known and may be used in practicing the present invention. For example, natural rubber, which is in the form of cis-1,4-polyisoprene, is found in latex within various trees, shrubs and plants, e.g., Hevea brasiliensis, (i.e., the Amazonian rubber tree), Castilla elastica (i.e., the Panama rubber tree), various Landophia vines (L. kirkii, L. heudelotis, and L. owariensis), various dandelions (i.e., Taraxacum species of plants), and Parthenium argentatum (guayule shrubs). It has been discovered that natural rubber from guayule, which may be referred to as guayule rubber, can form particularly advantageous cellular articles when practicing the present invention, and therefore the description of this invention may be made with reference to guayule rubber. Based upon this description, the skilled person will be able to extend the teachings of the present invention to other types of natural rubber. As the skilled person appreciates, the polymer obtained from guayule (Parthenium argentatu) is cis-1,4-polyisoprene, which may be referred to as guayule polymer, guayule polyisoprene, or guayule rubber.

In one or more embodiments, the guayule polymer (i.e. cis-1,4-polyisoprene) may be characterized by a number average molecular weight (Mₙ) of greater than 150, in other embodiments greater than 200, and in other embodiments greater than 225 kg/mol. In one or more embodiments, guayule polymer may have a number average molecular weight (Mₙ) of from about 150 to about 500 kg/mol, in other embodiments from about 200 to about 450 kg/mol, and in other embodiments from about 225 to about 400 kg/mol. In these or other embodiments, the guayule polymer may have a weight average molecular weight (M_{w}) of greater than 800, in other embodiments greater than 900, and in other embodiments greater than 950 kg/mol. In one or more embodiments, guayule polymer may have a weight average molecular weight (M_{w}) of from about 800 to about 3000 kg/mol, in other embodiments from about 900 to about 2000 kg/mol, and in other embodiments from about 950 to about 1500 kg/mol. In one or more embodiments, the guayule polymer has a molecular weight distribution (M_{w}/Mₚ) of less than 7, in other embodiments less than 6, in yet other embodiments less than 5.5, and in still other embodiments less than 5. In one or more embodiments, guayule polymer may have a molecular weight distribution of from about 3 to about 7, in other embodiments from about 4 to about 6, and in other embodiments from about 4.5 to about 5. The polymer molecular weight (M_{w} and Mₙ) can be determined by gel permeation chromatography (GPC) using THF as a solvent and polystyrene standards.

### Solvent

In one or more embodiments, the guayule cement includes a generally non-polar hydrocarbon solvent, which may be selected from C₅ to C₁₀ straight chain hydrocarbons, C₅ to C₁₀ branched chain hydrocarbons, C₅ to C₁₀ cyclic hydrocarbons, C₆ to C₁₀ aromatic hydrocarbons, and mixtures thereof. In various embodiments, combinations of solvents, including those that provide an azeotropic mixture, may be employed.

Specific examples of hydrocarbon solvents include pentane isomers such as n-pentane, iso-pentane, neo-pentane, and mixtures thereof, and hexane isomers such as n-hexane, iso-hexane, 3-methylpentant, 2,3-dimethylbutane, neo-hexane, cyclohexane, and mixtures thereof. Other useful examples include C₆ to C₁₀ aromatic hydrocarbons such as benzene, toluene, o-xylene, m-xylene, p-xylene, ethylbenzene, 1,2,3-trimethylbenzene, 1,2,4-trimethylbenzene, mesitylene, 2-ethyltoluene, 3-ethyltoluene, 4-ethyltoluene, and mixtures thereof.

In one or more embodiments, the guayule cement includes a mixture of a non-polar hydrocarbon solvent and a polar organic solvent. Useful polar organic solvents include acetone, C₁-C₄ alcohols, C₂-C₄ diols, and mixtures thereof. In particular embodiments, the solvent is a mixture of acetone and hexanes. In other particular embodiments, the solvent is a mixture of acetone and iso-hexane. In yet other particular embodiments, the solvent is a mixture of iso-hexane, cyclohexane and acetone.

In one or more embodiments, where the solvent is a mixture of polar and non-polar solvents, the mixture may include less than 50 wt %, in other embodiments less than 40 wt %, in other embodiments less than 30 wt %, and in other embodiments less than 20 wt % polar solvent, with the balance including non-polar solvent. In one or more embodiments, the mixture may include from about 1 to about 50 wt %, in other embodiments from about 10 to about 45 wt %, and in other embodiments from about 20 to about 40 wt % polar solvent with the balance including non-polar solvent.

### Characteristics of Cement

In one or more embodiments, the solids portion of the guayule cement includes greater than 85 wt %, in other embodiments greater than 90 wt %, and in other embodiments greater than 95 wt % cis-1,4-polyisoprene, based upon the total weight of the solids portion of the cement. In one or more embodiments, the solids portion of the cement includes from about 85 to about 99 wt %, in other embodiments from about 90 to about 98 wt %, and in other embodiments from about 95 to about 97 wt % cis-1,4-polyisoprene, based on the total weight of the solids portion of the cement.

In one or more embodiments, the guayule cement has a solids concentration of less than 12 wt %, in other embodiments less than 10 wt %, in other embodiments less than 9 wt %, and in other embodiments less than 8 wt %, based on the total weight of the cement. In these or other embodiments, the guayule cement has a solids concentration of greater than 4 wt %, in other embodiments greater than 5 wt %, and in other embodiments greater than 6 wt %, based on the total weight of the cement. In one or more embodiments, the guayule cement has a solids concentration of from about 4 to about 12 wt %, in other embodiments from about 4 to about 10 wt %, in other embodiments from about 5 to about 9 wt %, and in other embodiments from about 6 to about 8 wt %, based on the total weight of the cement.

In one or more embodiments, the solids portion of the guayule cement may include other constituents materials that are found within guayule and materials optionally added to the cement prior to addition of the particulate filler.

In one or more embodiments, the additional constituents within the solids portion of the cement that derive from guayule include guayule resin. As those skilled in the art appreciate, guayule resin generally refers to non-polyisoprene low molecular weight compounds that generally have a molecular weight of less than about 3000 g/mole. Examples of compounds within the resin include, but are not limited to, monoterpenes, triterpenes (Argentatin A, B and C), sesquiterpene compounds (Guayulin A and B) and fatty acids (as free fatty acid, monoglycerides, diglycerides, triglycerides, or a combination thereof). Additionally, solids portion of the cement may include low molecular weight polyisoprene polymers and oligomers.

In one or more embodiments, the solids portion of the guayule cement may be characterized by a relatively low content of guayule resin. For example, the solids content of the guayule cement may include less than 7 wt %, in other embodiments less than 6 wt %, and in other embodiments less than 5 wt % guayule resin or low molecular weight polyisoprene, based upon the total weight of the solids portion of the cement. In one or more embodiments, the solids portion of the cement includes from about 0.5 to about 7 wt %, in other embodiments from about 1 to about 6 wt %, and in other embodiments from about 2 to about 4 wt % guayule resin or low molecular weight polyisoprene, based on the total weight of the solids portion of the cement. In one or more embodiments, the weight ratio of guayule resin to low molecular weight polyisoprene may be from about 0.5:1 to about 1.5:1, in other embodiments from about 0.7:1 to about 1.3:1, and in other embodiments from about 0.9:1 to about 1.1:1.

In one or more embodiments, the solids portion of the guayule cement may include solids added to the cement prior to the addition of the particulate filler. In one or more embodiments, the solids portion of the cement may include an antidegradant such antioxidants and antiozonants. Examples of useful antidegradants include N,N′disubstituted-p-phenylenediamines, such as N-1,3-dimethylbutyl-N′phenyl-p-phenylenediamine (6PPD), N,N′-Bis(1,4-dimethylpently)-p-phenylenediamine (77PD), N-phenyl-N-isopropyl-p-phenylenediamine (IPPD), and N-phenyl-N′-(1,3-dimethylbutyl)-p-phenylenediamine (HPPD). Other examples of antidegradants include, acetone diphenylamine condensation product (Alchem BL), 2,4-trimethyl-1,2-dihydroquinoline (Alchem TMQ), octylated Diphenylamine (Alchem ODPA), and 2,6-di-t-butyl-4-methyl phenol (BHT).

When present, the solids portion of the cement may include less than 1 wt %, in other embodiments less than 0.5 wt %, and in other embodiments less than 0.3 wt % antidegradant, based on the total weight of the solids portion. In one or more embodiments, the solids portion includes from about 0.05 to about 1 wt %, in other embodiments from about 0.07 to about 0.5 wt %, and in other embodiments from about 0.1 to about 0.3 wt % antidegradant, based on the total weight of the solids portion.

### Obtaining Guayule Polymer

According to embodiments of the present invention, the process of the invention includes obtaining the guayule polymer from a guayule plant. In one or more embodiments, this process may include providing a guayule plant material, mechanically fracturing the plant material, extracting organic material from the fractured plant material to form a miscella, and fractionating the miscella to provide a cement or swollen polymer mass. The swollen polymer mass or cement may then be diluted to provide the cement with the desired solids content.

In one or more embodiments, the step of fracturing the guayule plant may include mechanically rupturing the stems by, for example, chopping, grinding, and/or macerating dried guayule stems. In one or more embodiments, these stems may include less than about 15 wt %, or in other embodiments less than 10 wt % leaves. In these or other embodiments, dried guayule stems include those that contain less than 25 wt %, or in other embodiments from about 5 to about 20 wt % moisture.

In one or more embodiments, the step of extracting the organic material from the fractured plant material includes combining the fractured plant material with a solvent that is adapted to dissolve the organic matter of the fractured plants. In one or more embodiments, the solvent includes a mixture of a hydrocarbon solvent (non-polar) and a polar organic solvent (e.g. 30 wt % acetone and 70 wt % hexanes). Those skilled in the art will be able to readily select an appropriate amount of solvent mixture to combine with the fractured plant material. For example, it may be common to add sufficient solvent to provide a weight ratio of solvent to bagasse of about 2:1 to about 4:1. The organic material that is dissolved in the solvent mixture is referred to as the miscella, and the miscella is then separated from the bagasse, which is the residual woody tissue. The separation of the miscella and the bagasse can be accomplished by using one or more known techniques including a multi-stage extraction technique and/or a countercurrent extraction technique.

Once the miscella is substantially separated from the bagasse, the miscella undergoes the step of fractionating to, among other things, separate those materials that are soluble in polar solvent (e.g. resin) from those constituents that are soluble in non-polar solvent (e.g. cis-1,4-polyisoprene). In one or more embodiments, the fractionating step includes the use of multistage countercurrent fractionation with concomitant addition of polar solvent (e.g. acetone) countercurrent to the flow of the miscella. Countercurrent fractionation and production of a swollen rubber mass is described, for example, in W. W. Schloman Jr., et al., “Processing Guayule for Latex and Bulk Rubber,” Industrial Crops and Products, 22, 41-47 (2005).

In one or more embodiments, the miscella can be diluted with additional acetone to precipitate the cis-1,4-polyisoprene in the form of a swollen rubber mass. The swollen rubber mass can then be diluted with additional hydrocarbon solvent or a mixture of at least one hydrocarbon solvent and at least one polar organic solvent to produce a cement with a desired solids content.

### Introducing Chemical Blowing Agent to Cement

As indicated above, once the desired guayule cement is provided to the process, a chemical blowing agent is introduced to the cement to form a solvent-borne mixture of natural rubber and chemical blowing agent. In certain embodiments, additional materials are introduced to the cement prior to desolventization. The cement may be mixed by using conventional techniques for mixing solutions during and after introduction of the chemical blowing agent. In particular embodiments, a reinforcing filler and optionally additional ingredients of the vulcanizable composition are introduced to the cement, along with the chemical blowing agent, to thereby form a solution masterbatch.

As the skilled person appreciates, a chemical blowing agent is a compound that undergoes decomposition based upon an external stimulant to form a gaseous compound. For example, useful chemical blowing agents include those compounds that decompose upon heating to release one or more gases such as, but not limited to, carbon dioxide, carbon monoxide, nitrogen gas, and ammonia.

Exemplary chemical blowing agents include azodicarbonamide (ADCA), azodiisobutyronitrile, benzenesulfonhydrazide, 4,4-oxybenzene sulfonyl-semicarbazide, p-toluene sulfonyl semicarbazide, barium azodicarboxylate, N,N′-dimethyl-N,N′-dinitrosoterephthalamide, and trihydrazinotriazine.

As the skilled person appreciates, the chemical blowing agent can be in the form of a solid particle at the time it is introduced to the cement. In one or more embodiments, the chemical blowing agent particles may have a median particle size (D50) of from about 0.5 to about 30 μm, in other embodiments from about 0.9 to about 20 μm, and in other embodiments from about 1.0 to about 10 μm. In these or other embodiments, the chemical blowing agent is a solid particle form having a median particle size of less than 25 μm, in other embodiments less than 15 μm, and in other embodiments less than 8 μm. In these or other embodiments, the chemical blowing agent is a solid characterized by a D90 particle size of less than 30 μm, in other embodiments less than 20 μm, and in other embodiments less than 10 μm.

In one or more embodiments, the chemical blowing agent can be characterized by a decomposition temperature. For purposes of this description, decomposition temperature refers to the temperature at which 25 wt % of the compound is decomposed. In one or more embodiments, the chemical blowing agent employed in practicing the present invention has a decomposition temperature of from about 175 to about 200° C., in other embodiments from about 180 to about 198° C., and in other embodiments from about 185 to about 195° C. In these or other embodiments, the chemical blowing is characterized by a decomposition temperature of greater than 160° C., in other embodiments greater than 170° C., and in other embodiments greater than 180° C.

Several techniques can be employed to introduce the chemical blowing agent to the guayule cement. In one or more embodiments, the chemical blowing agent is introduced directly to the cement in the form of a dry solid particulate. For example, the cement may be contained within a conventional stirred-tank reactor, and the chemical blowing agent can be added directly to the cement from the head space of the reactor in the form of a dry solid particulate.

In other embodiments, the chemical blowing agent particles are pre-mixed with a carrier prior to being introduced to the cement. In one or more embodiments, the chemical blowing agent particles are dispersed in a solvent to form solution or dispersion, which may be referred to as a blowing agent-solvent mixture, and the blowing agent-solvent mixture is introduced to the cement. For example, where the cement is contained in a conventional stirred-tank reactor, the blowing agent-solvent mixture can be introduced to the cement via the headspace of the reactor, or in the other embodiments, the mixture can be injected into the cement by an inlet located below the liquid level of the reactor or via a conduit extending into the liquid level of the reactor.

In those embodiments where a blowing agent-solvent mixture is formed, the blowing agent-solvent mixture may be characterized by a solids content (i.e. the weight of the blowing agent relative to the total weight of the mixture with the balance including the weight of the solvent) of less than 15 wt %, in other embodiments less than 12 wt %, and in other embodiments less than 10 wt % blowing agent, based on the total weight of the mixture. In these or other embodiments, the mixture may include from about 3 to about 15 wt %, in other embodiments from about 4 to about 12 wt %, and in other embodiments from about 5 to about 10 wt % blowing agent, based on the total weight of the mixture.

Where a blowing agent-solvent mixture is formed, the solvent employed to make the mixture may include a hydrocarbon solvent as described above with respect to the guayule cement. In other embodiments, the solvent may include a blend of hydrocarbon solvent and polar organic solvent (e.g. 30 wt % acetone and 70 wt % hexanes).

### Characteristics of Solvent-Borne Mixture

In one more embodiments, the solvent-borne mixture (i.e. blowing agent and rubber cement) may be characterized by the weight of blowing agent relative to the weight of the polymer. In one or more embodiments, the solvent-borne mixture includes less than 35, in other embodiments less than 25, and in other embodiments less than 20 parts by weight blowing agent per 100 parts by weight polymer. In these or other embodiments, the solvent-borne mixture includes greater than 1, in other embodiments greater than 5, and in other embodiments greater than 7 parts by weight blowing agent per 100 parts by weight polymer. In one or more embodiments, the solvent-borne mixture includes from about 1 to about 35, in other embodiments from about 3 to about 20, and in other embodiments from about 5 to about 15 parts by weight blowing agent per 100 parts by weight polymer.

### Filler Particles

As noted above, in one or more embodiments, filler particles may also be added to the cement (i.e. in addition to the blowing agent). These filler particles may include reinforcing filler. As those skilled in the art appreciate, reinforcing filler particles include carbon black filler particles. According to embodiments of the invention, carbon black is added in sufficient amounts to provide a desired weight ratio of carbon black to guayule rubber.

### Carbon Black

In one or more embodiments, useful carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In one or more embodiments, the carbon blacks employed in preparing the solution masterbatch may have a surface area of greater than 100 m²/g, in other embodiments greater than 115 m²/g, and in other embodiments greater than 130 m²/g. In these or other embodiments, the carbon blacks have a surface area of from about 100 to about 200 m²/g, in other embodiments from about 115 to about 175 m²/g, and in other embodiments from about 130 to about 150 m²/g. For purposes of this specification, and unless otherwise specified, carbon black surface area values are reported as N2 surface area determined by ASTM D-6556-19a.

In one or more embodiments, the carbon black that is combined with the guayule cement is unpelletized. In one or more embodiments, the carbon black that is added to the guayule cement is characterized by a median particle size (i.e. D50) of less than 65 nm, in other embodiments less than 60 nm, and in other embodiments less than 55 nm. In these or other embodiments, the carbon black is characterized by a median particle size of greater than 35 nm, in other embodiments greater than 40, and in other embodiments greater than 45 nm. In one or more embodiments, median particle size of the carbon black is from about 35 to about 65 nm, in other embodiments from about 40 to about 60 nm, and in other embodiments from about 45 to about 55 nm.

In those embodiments where a filler is introduced to the rubber cement, the solvent-borne mixture may be characterized by the weight of filler (e.g. carbon black) relative to the weight of the polymer. In one or more embodiments, the solvent-borne mixture includes less than 75, in other embodiments less than 65, and in other embodiments less than 55 parts by weight filler per 100 parts by weight polymer. In these or other embodiments, the solvent-borne mixture includes greater than 10, in other embodiments greater than 25, and in other embodiments greater than 35 parts by weight filler per 100 parts by weight polymer. In one or more embodiments, the solvent-borne mixture includes from about 10 to about 75, in other embodiments from about 25 to about 65, and in other embodiments from about 35 to about 55 parts by weight filler per 100 parts by weight polymer.

### Direct Desolventization

According to embodiments of the invention, the solvent-borne mixture (which includes blowing agent and polymer dispersed, dissolved, or suspended in solvent) is directly desolventized, which refers to a process whereby the solvent is separated from the solids portion of the mixture (i.e. separated from the polymer and blowing agent) to form a composition that is substantially a solid composite of the polymer and blowing agent (i.e. a nature rubber-chemical blowing agent composite). This can be distinguished from indirect desolventization methods such as steam desolventization whereby water is added to drive off the solvent and thereby produce a composition that would include water, polymer, and blowing agent.

Direct desolventization techniques, as well as the equipment for performing these methods, are generally known in the art. For example, the temperature of the solvent-borne mixture can be increased or maintained at a temperature sufficient to volatize the solvent. Also, the pressure within the vessel in which the desolventization is conducted can be decreased, which will assist in the volatilization of solvent. Still further, the solvent-borne mixture can be agitated, which may further assist in the removal of solvent from the mixture. In one embodiment, a combination of heat, decreased pressure, and agitation can be employed.

In one embodiment, the temperature of the solvent-borne mixture, together with the pressure of the environment in which the mixture is devolatilized (i.e. within the desolventization vessel), is adjusted to promote devolatilization. For example, the desolventization step may take place at a temperature of greater than 35° C., in other embodiments greater than 37° C., in other embodiments greater than 40° C., in other embodiments greater than 50° C., in other embodiments greater than 75° C., in other embodiments greater than 100° C., in other embodiments greater than 110° C., and in other embodiments greater than 120° C. under pressures of from about-5 to about-30 mm Hg. In one or more embodiments, the step of desolventization takes place at a temperature of from about 35 to about 160° C., in other embodiments from about 37 to about 140° C., and in other embodiments from about 40 to about 130° C. under pressures of from about-5 to about-30 mm Hg.

Various techniques can be employed to agitate and/or impart shear on the solvent-borne mixture during desolventization. As the skilled person will appreciate, agitation can expose greater surface area and thereby facilitate the evolution of solvent.

In one embodiment, desolventization can be accomplished by employing a drum dryer. In other embodiments, desolventization can be accomplished by employing a devolatizer. Devolatizers can include a devolatizing extruder, which typically includes a screw apparatus that can be heated by an external heating jacket. These extruders are known in the art and may include single and twin-screw extruders.

Alternatively, devolatizers can include extruder-like apparatus that include a shaft having paddles attached thereto. These extruder-like apparatuses can include a single shaft or multiple shafts. The shaft can be axial to the length of the apparatus and the flow of the solvent-borne mixture through the device/vessel. The composition (i.e. solvent-borne mixture) may be forced through the apparatus by using a pump, and the shaft rotates thereby allowing the paddles to agitate the composition and thereby assist in the evolution of solvent. The paddles can be angled so as to assist movement of the composition through the devolatilizer, although movement of the composition through the devolatilizer can be facilitated by the pump that can direct the composition into the devolatilizer and may optionally be further assisted by an extruder that may optionally be attached in series or at the end of the devolatilizer (i.e., the extruder helps pull the composition through the devolatilizer).

Devolatilizers can further include backmixing vessels. In general, these backmixing vessels include a single shaft that includes a blade that can be employed to vigorously mix and masticate the composition (i.e. the solvent-borne mixture).

In certain embodiments, combinations of the various devolatilizing equipment can be employed to achieve desired results. These combinations can also include the use of extruders. In one example, a single shaft “extruder-like” devolatilizer (e.g., one including paddles) can be employed in conjunction with a twin-screw extruder. In this example, the solvent-borne mixture first enters the “extruder-like” devolatilizer followed by the twin-screw extruder. The twin-screw extruder advantageously assists in pulling the composition through the devolatilizer. The paddles of the devolatilizer can be adjusted to meet conveyance needs.

In another example, a twin shaft “extruder-like” devolatilizer can be employed. In certain embodiments, the paddles on each shaft may be aligned so as to mesh with one another as they rotate. The rotation of the shafts can occur in the same direction or in opposite directions.

In yet another example, a backmixing volatilizing vessel can be followed by a twin-screw extruder, which can then be followed by a twin shaft extruder-like devolatilizing vessel, which can then be following by a twin-screw extruder.

Devolatilizing equipment is known in the art and commercially available. For example, devolatilizing equipment can be obtained from LIST (Switzerland); Coperion Werner & Phleiderer; or NFM Welding Engineers, Inc. (Ohio). Exemplary equipment available from LIST include DISCOTHERM™, which is a single shaft “extruder-like” devolatilizer including various mixing/kneading bars or paddles; CRP™, which is a dual shaft “extruder-like” devolatilizer wherein each shaft correlates with the other; ORP™, which is a dual shaft devolatilizer wherein each shaft rotates in an opposite direction to the other.

As described above, desolventization of the solvent-borne mixture results in a natural rubber-chemical blowing agent composite that can be used to form a foamable, vulcanizable composition.

### Foamable, Vulcanizable Composition

According the present invention, the natural rubber-chemical blowing agent composite, which may also be referred to as a rubber-chemical blowing agent solid mixture, prepared as described above are used in the preparation of a foamable, vulcanizable composition that can be foamed and cured. In addition to the natural rubber and chemical blowing agent, the vulcanizable compositions may also include other constituents such as, but not limited to, synthetic elastomeric polymers, non-guayule natural rubber, reinforcing fillers, plasticizers, and curatives. Specific examples of these ingredients include, but not limited to, carbon black, silica, fillers, oils, resins, waxes, metal carboxylates, cure agents and cure coagents, anti-degradants, and metal oxides.

Exemplary elastomeric polymers that are useful in the practice of the present invention (i.e. included within the vulcanizable compositions), which may also be referred to as rubber polymers or vulcanizable polymers, include polydienes and polydiene copolymers. Specific examples of these polymer include, but are not limited to, polybutadiene, poly(styrene-co-butadiene), polyisoprene, poly(styrene-co-isoprene), and functionalized derivatives thereof. Other polymers that may be included in the polymer sample include neoprene, poly(ethylene-co-propylene), poly(styrene-co-butadiene), poly(ethylene-co-propylene-co-diene), polysulfide rubber, acrylic rubber, urethane rubber, silicone rubber, epichlorohydrin rubber, syndiotactic polybutadiene, and mixtures thereof or with polydienes and polydiene copolymers. These elastomers can have a myriad of macromolecular structures including linear, branched, and star-shaped structures. These elastomers may also include one or more functional units, which typically include heteroatoms tethered to the backbone of the polymer.

In one or more embodiments, useful carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In one or more embodiments, suitable silica fillers include precipitated amorphous silica, wet silica (hydrated silicic acid), dry silica (anhydrous silicic acid), fumed silica, calcium silicate, aluminum silicate, calcium aluminum silicate, magnesium silicate, and the like.

In one or more embodiments, the surface area of the silica, as measured by the BET method, may be from about 32 to about 400 m²/g (including 32 m²/g to 400 m²/g), with the range of about 100 m²/g to about 300 m²/g (including 100 m²/g to 300 m²/g) being preferred, and the range of about 150 m²/g to about 220 m²/g (including 150 m²/g to 220 m²/g) being included. In one or more embodiments, the silica may be characterized by a pH of about 5.5 to about 7 or slightly over 7, or in other embodiments from about 5.5 to about 6.8. Some of the commercially available silica fillers that can be used include, but are not limited to, those sold under the tradename Hi-Sil, such as 190, 210, 215, 233, and 243, by PPG Industries, as well as those available from Degussa Corporation (e.g., VN2, VN3), Rhone Poulenc (e.g., Zeosil™ 1165 MP), and J. M. Huber Corporation.

In one or more embodiments, silica coupling agents are included in the vulcanizable composition. As the skilled person appreciates, these compounds include a hydrolyzable silicon moiety (often referred to as a silane) and a moiety that can react with a vulcanizable polymer.

Suitable silica coupling agents include, for example, those containing groups such as alkyl alkoxy, mercapto, blocked mercapto, sulfide-containing (e.g., monosulfide-based alkoxy-containing, disulfide-based alkoxy-containing, tetrasulfide-based alkoxy-containing), amino, vinyl, epoxy, and combinations thereof. In certain embodiments, the silica coupling agent can be added to the rubber composition in the form of a pre-treated silica; a pre-treated silica has been pre-surface treated with a silane prior to being added to the rubber composition.

Non-limiting examples of alkyl alkoxysilanes suitable for use in certain embodiments of the fourth embodiment disclosed herein include, but are not limited to, octyltriethoxysilane, octyltrimethoxysilane, trimethylethoxysilane, cyclohexyltriethoxysilane, isobutyltriethoxy-silane, ethyltrimethoxysilane, cyclohexyl-tributoxysilane, dimethyldiethoxysilane, methyltriethoxysilane, propyltriethoxysilane, hexyltriethoxysilane, heptyltriethoxysilane, nonyltriethoxysilane, decyltriethoxysilane, dodecyltriethoxysilane, tetradecyltriethoxysilane, octadecyltriethoxysilane, methyloctyldiethoxysilane, dimethyldimethoxysilane, methyltrimethoxysilane, propyltrimethoxysilane, hexyltrimethoxysilane, heptyltrimethoxysilane, nonyltrimethoxysilane, decyltrimethoxysilane, dodecyltrimethoxysilane, tetradecyltrimethoxysilane, octadecyl-trimethoxysilane, methyloctyl dimethoxysilane, and mixtures thereof.

Non-limiting examples of bis(trialkoxysilylorgano) polysulfides suitable for use in certain embodiments of the fourth embodiment disclosed herein include bis(trialkoxysilylorgano)disulfides and bis(trialkoxysilylorgano)tetrasulfides. Specific non-limiting examples of bis(trialkoxysilylorgano)disulfides suitable for use in certain exemplary embodiments of the fourth embodiment disclosed herein include, but are not limited to, 3,3′-bis(triethoxysilylpropyl) disulfide, 3,3′-bis(trimethoxysilylpropyl) disulfide, 3,3′-bis(tributoxysilylpropyl) disulfide, 3,3′-bis(tri-t-butoxysilylpropyl) disulfide, 3,3′-bis(trihexoxysilylpropyl) disulfide, 2,2′-bis(dimethylmethoxysilylethyl)disulfide, 3,3′-bis(diphenylcyclohexoxysilylpropyl) disulfide, 3,3′-bis(ethyl-di-sec-butoxysilylpropyl) disulfide, 3,3′-bis(propyldiethoxysilylpropyl) disulfide, 12,12′-bis(triisopropoxysilylpropyl) disulfide, 3,3′-bis(dimethoxyphenylsilyl-2-methylpropyl) disulfide, and mixtures thereof. Non-limiting examples of bis(trialkoxysilylorgano)tetrasulfide silica coupling agents suitable for use in certain embodiments of the fourth embodiment disclosed herein include, but are not limited to, bis(3-triethoxysilylpropyl) tetrasulfide, bis(2-triethoxysilylethyl)tetrasufide, bis(3-trimethoxysilylpropyl) tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof. Bis(3-triethoxysilylpropyl) tetrasulfide is sold under the tradename Si 69 by Evonik Degussa Corporation.

Non-limiting examples of mercapto silanes suitable for use in certain embodiments of the fourth embodiment disclosed herein include, but are not limited to, 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltripropoxysilane, 18-mercaptooctadecyldiethoxychlorosilane, and mixtures thereof.

Non-limiting examples of blocked mercapto silanes suitable for use in certain embodiment of the fourth embodiment disclosed herein include, but are not limited to, those described in U.S. Pat. Nos. 6,127,468; 6,204,339; 6,528,673; 6,635,700; 6,649,684; and 6,683,135, the disclosures of which are hereby incorporated by reference. Representative examples of the blocked mercapto silanes for use herein in certain exemplary embodiments disclosed herein include, but are not limited to, 2-triethoxysilyl-1-ethylthioacetate; 2-trimethoxysilyl-1-ethylthioacetate; 2-(methyldimethoxysilyl)-1-ethylthioacetate; 3-trimethoxysilyl-1-propylthioacetate; triethoxysilylmethyl-thioacetate; trimethoxysilylmethylthioacetate; triisopropoxysilylmethylthioacetate; methyldimethoxysilylmethylthioacetate; methyldiethoxysilylmethylthioacetate; dimethylethoxysilylmethylthioacetate; methyldiisopropoxysilylmethylthioacetate; dimethylmethoxysilylmethylthioacetate; dimethylisopropoxysilylmethylthioacetate; 2-triisopropoxysilyl-1-ethylthioacetate; 2-(methyldiethoxysilyl)-1-ethylthioacetate, 2-(methyldiisopropoxysilyl)-1-ethylthioacetate; 2-(dimethylethoxysilyl-1-ethylthioacetate; 2-(dimethylmethoxysilyl)-1-ethylthioacetate; 2-(dimethylisopropoxysilyl)-1-ethylthioacetate; 3-triethoxysilyl-1-propylthioacetate; 3-triisopropoxysilyl-1-propylthioacetate; 3-methyldiethoxysilyl-1-propyl-thioacetate; 3-methyldimethoxysilyl-1-propylthioacetate; 3-methyldiisopropoxysilyl-1-propylthioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxy-silyl-1-ethyl)-4-thioacetylnorbornene; 1-(1-oxo-2-thia-5-triethoxysilylphenyl)benzoic acid; 6-triethoxysilyl-1-hexylthioacetate; 1-triethoxysilyl-5-hexylthioacetate; 8-triethoxysilyl-1-octylthioacetate; 1-triethoxysilyl-7-octylthioacetate; 6-triethoxysilyl-1-hexylthioacetate; 1-triethoxysilyl-5-octylthioacetate; 8-trimethoxysilyl-1-octylthioacetate; 1-trimethoxysilyl-7-octylthioacetate; 10-triethoxysilyl-1-decylthioacetate; 1-triethoxysilyl-9-decylthioacetate; 1-triethoxysilyl-2-butylthioacetate; 1-triethoxysilyl-3-butylthioacetate; 1-triethoxysilyl-3-methyl-2-butylthioacetate; 1-triethoxysilyl-3-methyl-3-butylthioacetate; 3-trimethoxysilyl-1-propylthiooctanoate; 3-triethoxysilyl-1-propyl-1-propylthiopalmitate; 3-triethoxysilyl-1-propylthiooctanoate; 3-triethoxysilyl-1-propylthiobenzoate; 3-triethoxysilyl-1-propylthio-2-ethylhexanoate; 3-methyldiacetoxysilyl-1-propylthioacetate; 3-triacetoxysilyl-1-propylthioacetate; 2-methyldiacetoxysilyl-1-ethylthioacetate; 2-triacetoxysilyl-1-ethylthioacetate; 1-methyldiacetoxysilyl-1-ethylthioacetate; 1-triacetoxysilyl-1-ethyl-thioacetate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1-propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)-ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulfate; 3-triethoxysilyl-1-propylmethanethiosulfonate; 3-triethoxysilyl-1-propylethanethiosulfonate; 3-triethoxysilyl-1-propylbenzenethiosulfonate; 3-triethoxysilyl-1-propyltoluenethiosulfonate; 3-triethoxysilyl-1-propylnaphthalenethiosulfonate; 3-triethoxysilyl-1-propylxylenethiosulfonate; triethoxysilyl methyl methylthiosulfate; triethoxysilylmethylmethanethiosulfonate; triethoxysilylmethylethanethiosulfonate; triethoxysilylmethylbenzenethiosulfonate; triethoxysilylmethyltoluenethiosulfonate; triethoxysilylmethylnaphthalenethiosulfonate; triethoxysilylmethylxylenethiosulfonate, and the like. Mixtures of various blocked mercapto silanes can be used. A further example of a suitable blocked mercapto silane for use in certain exemplary embodiments is that sold under the tradename NXT silane (3-octanoylthio-1-propyltriethoxysilane) by Momentive Performance Materials Inc.

In one or more embodiments, plasticizers include oils and solids resins. Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils. Suitable low PCA oils also include various plant-sourced oils such as can be harvested from vegetables, nuts, and seeds. Non-limiting examples include, but are not limited to, soy or soybean oil, sunflower oil, safflower oil, corn oil, linseed oil, cotton seed oil, rapeseed oil, cashew oil, sesame oil, camellia oil, jojoba oil, macadamia nut oil, coconut oil, and palm oil. As is generally understood in the art, oils refer to those compounds that have a viscosity that is relatively low compared to other constituents of the vulcanizable composition, such as the resins. In one or more embodiments, the resins may be solids with a Tg of greater than about 20° C., and may include, but are not limited to, hydrocarbon resins such as cycloaliphatic resins, aliphatic resins, aromatic resins, terpene resins, and combinations thereof. Useful resins include, but are not limited to, styrene-alkylene block copolymers, thermoplastic resins such as C₅-based resins, C₅-C₉-based resins, C₉-based resins, terpene-based resins, terpene-aromatic compound-based resins, rosin-based resins, dicyclopentadiene resins, alkylphenol-based resins, and their partially hydrogenated resins.

In one or more embodiments, the vulcanizable compositions of this invention include a cure system. The cure system includes a curative, which may also be referred to as a crosslinking agent, rubber curing agent or vulcanizing agents. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. In one or more embodiments, useful cure systems include sulfur or sulfur-based cross-linking agents, organic peroxide-based crosslinking agents, inorganic crosslinking agents, polyamines crosslinking agents, resin crosslinking agents, oxime-based and nitrosamine-based cross-linking agents, and the like. Examples of suitable sulfur crosslinking agents include “rubbermaker's” soluble sulfur; sulfur donating vulcanizing agents, such as an amine disulfide, polymeric polysulfide or sulfur olefin adducts; and insoluble polymeric sulfur. In other embodiments, the crosslinking agents include sulfur and/or sulfur-containing compounds. In other embodiments, the crosslinking agent excludes sulfur and/or sulfur-containing compounds. Vulcanizing agents may be used alone or in combination.

Other ingredients that are typically employed in rubber compounding may also be added to the rubber compositions. These include accelerators, accelerator activators, additional plasticizers, waxes, scorch inhibiting agents, processing aids, zinc oxide, tackifying resins, reinforcing or hardening resins, fatty acids such as stearic acid, peptizers, and antidegradants such as antioxidants and antiozonants.

### Ingredient Amounts

The vulcanizable compositions can be characterized by the total polymeric content (i.e. polymer introduced via polymer-blowing agent agglomerates and polymer elastomer added to the vulcanizable composition). In one or more embodiments, the vulcanizable compositions include greater than 20 wt %, in other embodiments greater than 30 wt %, and in other embodiments greater than 40 wt % polymeric content (e.g. elastomer), based on the total weight of the vulcanizable composition. In these or other embodiments, the vulcanizable compositions include less than 80 wt %, in other embodiments less than 70 wt %, and in other embodiments less than 60 wt % polymeric content (e.g. elastomer), based on the total weight of the vulcanizable composition. In one or more embodiments, the vulcanizable compositions include from about 20 to about 80 wt %, in other embodiments from about 30 to about 70 wt %, and in other embodiments from about 40 to about 60 wt % polymeric content (e.g. elastomer), based on the total weight of the vulcanizable composition polymeric content (e.g. elastomer), based on the total weight of the vulcanizable composition.

In one or more embodiments, the vulcanizable compositions include a filler such as carbon black or silica. In one or more embodiments, the vulcanizable compositions include greater than 10 parts by weight (pbw), in other embodiments greater than 35 pbw, and in other embodiments greater than 55 pbw filler (e.g. carbon black and or silica) per one hundred parts by weight of the rubber (phr). In these or other embodiments, the vulcanizable compositions include less than 140 pbw, in other embodiments less than 95 pbw, and in other embodiments less than 75 pbw filler phr. In one or more embodiments, the vulcanizates include from about 10 to about 200 pbw, in other embodiments from about 10 to about 140 pbw, in other embodiments from about 35 to about 95 pbw, in other embodiments from about 40 to about 130 pbw, in other embodiments from about 50 to about 120 pbw, and in other embodiments from about 55 to about 75 pbw filler (e.g. carbon black and or silica) phr. Carbon black and silica may be used in conjunction at a weight ratio of silica to carbon black of from about 0.1:1 to about 30:1, in other embodiments of from about 0.5 to about 20:1, and in other embodiments from about 1:1 to about 10:1.

In one or more embodiments, where silica is used as a filler, the vulcanizable compositions may include silica coupling agent. In one or more embodiments, the vulcanizable compositions may generally include greater than 1, in other embodiments greater than 2, and in other embodiments greater than 3 pbw silica coupling agent phr. In these or other embodiments, the vulcanizable compositions may generally include less than 40, in other embodiments less than 20, and in other embodiments less than 10 pbw silica coupling agent phr. In one or more embodiments, the vulcanizable compositions include from about 1 to about 40 pbw, in other embodiments from about 2 to about 20 pbw, in other embodiments from about 2.5 to about 15 pbw, and in other embodiments from about 3 to about 10 pbw silica coupling agent phr.

In these or other embodiments, the amount of silica coupling agent may be defined relative to the weight of the silica. In one or more embodiments, the amount of silica coupling agent introduced to the silica (either in situ or pre-reacted) is from about 1 to about 25 pbw, in other embodiments from about 2 to about 20 pbw, and in other embodiments from about 3 to about 15 pbw silica coupling agent per one hundred parts by weight of the silica.

The vulcanizable compositions may generally include greater than 5, in other embodiments greater than 10, and in other embodiments greater than 20 pbw plasticizer (e.g. oils and solid resins) phr. In these or other embodiments, the vulcanizable compositions may generally include less than 80, in other embodiments less than 70, and in other embodiments less than 60 pbw plasticizer phr. In one or more embodiments, vulcanizable compositions may generally include from about 5 to about 80, in other embodiments from about 10 to about 70, and in other embodiments from about 20 to about 60 pbw plasticizer phr. In further embodiments, the vulcanizable compositions may include less than 15 pbw, alternatively less than 10 pbw, or less than 5 pbw of liquid plasticizer. In certain embodiments, the vulcanizable compositions are devoid of liquid plasticizer. In alternative embodiments, the vulcanizable compositions may include at least 20 pbw of resin, at least 25 pbw resin or at least 30 pbw resin.

The skilled person will be able to readily select the amount of vulcanizing agents to achieve the level of desired cure. In particular embodiments, sulfur is used as the cure agent. In one or more embodiments, the vulcanizable compositions may include greater than 0.5, in other embodiments greater than 1, and in other embodiments greater than 2 pbw sulfur phr. In these or other embodiments, the vulcanizable compositions may generally include less than 10, in other embodiments less than 7, and in other embodiments less than 5 pbw sulfur phr. In one or more embodiments, the vulcanizable compositions may generally include from about 0.5 to about 10, in other embodiments from about 1 to about 6, and in other embodiments from about 2 to about 4 pbw sulfur phr.

### Preparation of Foamable, Vulcanizable Composition

The foamable, vulcanizable compositions may be prepared using conventional mixing techniques. For example, the ingredients of the vulcanizable composition can be introduced within a mixing device and mixed in the solid state. The foamable, vulcanizable composition is then formed into a green vulcanizate and then subjected to conditions to effect foaming and vulcanizing (i.e. curing or crosslinking) of the polymeric network.

For example, all ingredients of the vulcanizable compositions can be mixed with standard mixing equipment such as Banbury or Brabender mixers, extruders, kneaders, and two-roll mills. In one or more embodiments, this may include a multi-stage mixing procedure where the ingredients are introduced and/or mixed in two or more stages. For example, in a first stage (which is often referred to as a masterbatch mixing stage), the natural rubber-chemical blowing agents of this invention, together with optional additional filler and optional ingredients are mixed. In one or more embodiments, where a silica coupling agent is used, it too may be added during one or more masterbatch stages. Generally speaking, masterbatch mixing steps include those steps where an ingredient is added and mixing conditions take place at energies (e.g. temperature and shear) above that which would scorch the composition in the presence of a curative. Similarly, re-mill mixing stages take place at the same or similar energies except an ingredient is not added during a re-mill mixing stage. It is believed that the energies imparted to the vulcanizable composition during masterbatch or re-mill mixing is sufficient to disperse the filler and to cause hydrolysis and subsequent condensation of the hydrolyzable groups. For example, it is believed that during one or more of these mix stages, the hydrolyzable groups of the silica functionalizing agents hydrolyze and then, via a condensation reaction, bond to the silica particles. To this end, in one or more embodiments, masterbatch or re-mill mixing may take place in presence of a catalyst that serves to promote the reaction between the hydrolyzable groups and the silica. These catalysts are generally known in the art and include, for example, strong bases such as, but not limited to, alkali metal alkoxides, such as sodium or potassium alkoxide; guanidines, such as triphenylguanidine, diphenylguanidine, di-o-tolylguanidine, N,N,N′,N′-tetramethylguanidine, and the like; and hindered amine bases, such as 1,8-diazabicyclo[5.4.0]undec-7-ene, 1,5-diazabicyclo[4.3.0]non-5-ene, and the like, tertiary amine catalysts, such as N,N-dimethylcyclohexylamine, triethylenediamine, triethylamine, and the like, quaternary ammonium bases, such as tetrabutylammonium hydroxide, and bisaminoethers, such as bis(dimethylaminoethyl) ethers.

Accordingly, masterbatch and re-mill mixing takes place in the absence of the curative and proceed at temperatures above which the curing would otherwise take place if the curative was present. For example, this mixing can take place at temperatures in excess of 120° C., in other embodiments in excess of 130° C., in other embodiments in excess of 140° C., and in other embodiments in excess of 150° C. It will also be appreciated that the mixing steps (e.g. masterbatch and re-mill mixing steps) take place a temperature below the decomposition temperature of the chemical blowing agent. For example, mixing takes place at maximum temperatures (i.e. the maximum temperature achieved by the composition) of less than 175° C., in other embodiments less than 170° C., and in other embodiments less than 165° C.

Once the masterbatch is prepared, the vulcanizing agents may be introduced and mixed into the masterbatch in a final mixing stage, which is typically conducted at relatively low temperatures so as to reduce the chances of premature vulcanization. For example, this mixing may take place at temperatures below 120° C., in other embodiments below 110° C., in other embodiments below 100° C. Additional mixing stages, sometimes called remills, can be employed between the masterbatch mixing stage and the final mixing stage.

In one or more embodiments, and regardless of the mixing techniques and temperature profiles used, it should be understood that mixing temperatures, which includes the temperature at which the foamable, vulcanizable composition reaches peak temperature during mixing, should remain below the decomposition temperature of the chemical blowing agent.

### Preparation of Foamed Vulcanizate

The foamable, vulcanizable composition is then fabricated into a desired shape, which may be referred to as profile. This may include extruding a desired profile, or in other embodiments, this may include placing the vulcanizable composition into a desired mold.

In one or more embodiments, the vulcanizate is prepared by subjecting the foamable, vulcanizable composition to conditions to decompose the chemical blowing agent and thereby foam the composition, and then vulcanize or otherwise cure the rubber within the composition. In one or more embodiments, the steps of decomposing the chemical blowing agent and vulcanizing the rubber take place simultaneously. In other words, by heating the foamable, vulcanizable composition to threshold temperatures, decomposition and vulcanization can take place simultaneously. In other embodiments, decomposition of the chemical blowing agent can take place first followed by vulcanization. In yet other embodiments, the chemical blowing agent is partially decomposed and then vulcanization takes place.

In one or more embodiments, the profile is heated to decompose the chemical blowing agent and vulcanize the rubber. In one or more embodiments, the profile is heated to a temperature of from about 175 to about 215° C., in other embodiments from about 180 to about 210° C., and in other embodiments from about 185 to about 205° C. In one or more embodiments, the profile is heated for a time to at least decompose 40 weight percent of the chemical blowing agent. In one or more embodiments, the profile is maintained at the desired temperature for at least 5 minutes, in other embodiments at least 7 minutes, and in other embodiments at least 9 minutes. In these or other embodiments, the profile is maintained at the desired temperature from about 5 to about 15 minutes or in other embodiments from about 7 to about 12 minutes.

### INDUSTRIAL APPLICABILITY

As indicated above, the foamable, vulcanizable compositions of the present invention can be cured to prepare various tire components. In one or more embodiments, these components include pneumatic tire components such as, without limitation, tire treads, tire sidewalls, belt skims, innerliners, ply skims, and bead apex. These tire components can be included within a variety of vehicle tires including passenger tires, truck-bus tires, and off-the-road tires.

In one or more embodiments, the foamed article produced by practice of the present invention may be characterized by reduced density relative to a solid of the same profile. As the skilled person appreciates, this density can be calculated by measuring the mass (i.e. weight) and volume of the foamed article. In one or more embodiments, the foamed article has a density of less than 1000 kg/m³, in other embodiments less than 900 kg/m³, and in other embodiments less than 800 kg/m³. In these or other embodiments, the foamed article has a density of from about 500 to about 900, in other embodiments from about 550 to about 850, and in other embodiments from about 600 to about 800 kg/m³.

### EXPERIMENTAL SECTION

Two vulcanizable compositions were prepared by using the recipes provided in Table I below. While both samples used guayule rubber (GR) that was obtained from a guayule rubber cement and dried, Sample 1 included a chemical blowing agent that was introduced to the cement and solution mixed according to the present invention. Sample 2, which was a control, was prepared using the same drying and compounding conditions without the addition of the chemical blowing agent (CBA).

The chemical blowing agent was azodicarbonamide, and it was characterized by having an average particle size of 5 μm, and a decomposition temperature of 202-204° C. For Sample 1, 12.5 phr of CBA was first dispersed in 930 ml of GR cement under continuous stirring at 12,000 rpm for 20 min at room temperature. The GR cement contained 7% of GR with weight average molecular weight of about 900 kg/mol, and the ratio between hexane:acetone in the cement was 80:20. Both solutions were drum dried at 150° C. to remove the solvent, and the dried polymer of each respective sample was then mixed with the other ingredients within a 65 g Brabender mixer at 100° C. for 3 min at 60 rpm. The compositions were then sheeted out and cut into 3×3×0.075 inch sample for compression molding. The samples were compression molded at 200° C. for 10 min under the pressure of 8.2 MPa for curing and foaming.

TABLE I

| Sample | 1 | 2 |
|---|---|---|
| GR/CBA_SMB | 112.5 | 0 |
| GR | 0 | 100 |
| Stearic acid | 2 | 2 |
| Wax | 1 | 1 |
| 6PPD | 1 | 1 |
| CBS accelerator | 1.3 | 1.3 |
| TMQ Antioxidant | 0.3 | 0.3 |
| ZnO | 3.5 | 3.5 |
| Sulfur | 1 | 1 |

The cured samples were analyzed for tensile properties and the results of the tests are set forth in Table II below. Also, the foam of Sample 1 had a density of 697.7 kg/m³ compared to the solid profile of Sample 2, which had a density of 974.5 kg/m³.

TABLE II

| | 50% | 100% | 200% | 300% | 400% | Maximum | | |
|---|---|---|---|---|---|---|---|---|
| | Modulus | Modulus | Modulus | Modulus | Modulus | Stress | Strain @ | Toughness |
| Sample | (MPa) | (MPa) | (MPa) | (MPa) | (MPa) | (MPa) | break (%) | (MPa) |
| 1 | 0.31 | 0.473 | 0.906 | 1.869 | 3.481 | 4.7 | 476.37 | 8.275 |
| 2 | 0.309 | 0.408 | 0.566 | 0.741 | 0.962 | 2 | 655.332 | 6.221 |

The foam of Sample 1 shows enhanced tensile modulus, stress and toughness compared to the solid GR. It is expected that the enhanced tensile performance of GR-foam is due to the unique porous structure induced enhanced strain induced crystallization.

Various modifications and alterations that do not depart from the scope and spirit of this invention will become apparent to those skilled in the art. This invention is not to be duly limited to the illustrative embodiments set forth herein.

1. A method for forming a natural rubber-chemical blowing agent composite, the method comprising:
(a) providing a natural rubber cement;
(b) introducing a blowing agent to the natural rubber cement to form a solvent-borne mixture including the natural rubber and blowing agent; and
(c) desolventizing the solvent-borne mixture to form a natural rubber-chemical blowing agent composite.

2. The method of claim 1, where the natural rubber cement is guayule cement.

3. The method of claim 2, where the guayule cement includes less than 12 wt % polymer.

4. The method of claim 1, where the chemical blowing agent has a decomposition temperature of greater than 160° C.

5. The method of claim 1, where the chemical blowing agent is in the form of a particulate having a median particle size of from about 0.5 to about 30 μm.

6. The method of claim 1, where the chemical blowing agent is dispersed in a carrier solvent prior to said step of introducing the chemical blowing agent to the guayule cement.

7. The method of claim 1, where said step of desolventizing includes direct desolventizing techniques.

8. The method of claim 1, where said step of desolventizing includes evaporatively separating solvent from the solvent-borne mixture.

9. The method of claim 2, where the guayule cement includes a solids portion including cis-1,4-polyisoprene obtained from guayule.

10. The method of claim 2, where the guayule cement includes a solids portion including resin obtained from guayule.

11. The method of claim 2, where the solids portion of the guayule cement includes greater than 85 wt % cis-1,4-polyisoprene obtained from guayule.

12. The method of claim 2, where the solids portion of the guayule cement includes from about 0.5 to about 7 wt % guayule resin or low molecular weight polyisoprene.

13. The method of claim 2, where the guayule cement includes a hydrocarbon solvent.

14. The method of claim 2, where the guayule cement includes a hydrocarbon solvent and a polar organic solvent.

15. A method for forming a foamed rubber article, the method comprising:
(a) providing the natural rubber-chemical blowing agent composite of claim 1;
(b) introducing a curative to the composite to form a foamable, vulcanizable composition;
(c) forming a profile from the foamable, vulcanizable composition; and
(d) heating the profile to a temperature sufficient to decompose the chemical blowing agent and vulcanize the rubber.
